(19) United States
(12) Patent Application Publication
(10) Pub. No.: US 2018/0037512 A1
(43) Pub. Date: Feb. 8, 2018

(54) FIBER UNWINDING SYSTEM AND METHODS OF UNWINDING A FIBER FROM A BOBBIN

(71) Applicant: General Electric Company, Schenectady, NY (US)

(72) Inventors: Theodore Robert Grossman, Cincinnati, OH (US); Roger Antonio Aparicio, Middletown, DE (US); Martin Peter Gill, Newark, DE (US); Steven Robert Hayashi, Niskayuna, NY (US); Andrew William Miller, Lincoln University, PA (US)

(21) Appl. No.: 15/227,354

(22) Filed: Aug. 3, 2016

(51) Int. Cl. C04B 35/80; C04B 35/657; B65H 49/34; C04B 35/628; B05D 3/00; D06M 13/53

(52) U.S. Cl. CPC C04B 35/806; B05D 3/007; D06M 13/53; B65H 49/34; C04B 35/62868; C04B 35/657; B65H 2701/314; C04B 2235/3826; C04B 2235/428; C04B 2235/5244; C04B 2235/616

(57) ABSTRACT

Methods for coating a fiber are provided. The method can include unwinding a silicon carbide-containing fibrous material from a bobbin rotatably mounted around an axle and forming a boron nitride coating onto the silicon carbide-containing fibrous material. The bobbin is moved along the axial direction such that the silicon carbide-containing fibrous material defines an unwind angle with the axial direction, with the unwind angle being maintained between about 80° to about 100°.

### FIELD OF THE INVENTION

The described subject matter relates generally to composite materials and more specifically to methods for manufacturing composite materials.

### BACKGROUND OF THE INVENTION

Due to high thermal and mechanical performance, coupled with relatively low density, numerous components could benefit from the use of Ceramic Matrix Composites (CMCs) in place of metals or intermetallics. During the manufacturing processes of CMC, the fibers need to be coated in order to survive the processes as well as for mechanical properties in service. Currently, two of the primary cost-effective methods of processing ceramic matrix composite (CMC) components are chemical vapor infiltration (CVI) and polymer infiltration and pyrolysis (PIP). Another process is glass transfer molding, which is faster than CVI and PIP, but is also much more expensive and resource intensive. Each of these processes uses a filament handling device using various forms of tension control on fiber movement during processing.

In the fiber coating process, fibers are typically unwound from a spindle to begin processing. During the unwind process, tension of the filaments is carefully controlled, since too much tension could destroy the filaments while not enough tension can allow the tow to jump off rollers and mis-track. In a fiber coating process, tension can also affect filament spacing which, in turn, can affect coating thickness uniformity and mechanical properties. In a conventional filament handling apparatus, the fiber bundles often break in midstream at any place along the fiber path length and breakage often occurs due to a failure in a process of unwinding the fiber bundles from fiber bundle feeding packages. The breakage of the fiber bundle typically occurs when friction exceeds the fiber strength or one or more of a plurality of single fibers of the fiber bundle is snarled or tangled at the time of unwinding process.

Thus, a need exists for an automated device that is constantly correcting, adjusting and maintaining the unwinding process of the tow during fiber processing.

### BRIEF DESCRIPTION OF THE INVENTION

Aspects and advantages of the invention will be set forth in part in the following description, or may be obvious from the description, or may be learned through practice of the invention.

Methods are generally provided for coating a fiber. In one embodiment, the method includes unwinding a silicon carbide-containing fibrous material from a bobbin rotatably mounted around an axle and forming a boron nitride coating onto the silicon carbide-containing fibrous material. The bobbin is moved along the axial direction such that the silicon carbide-containing fibrous material defines an unwind angle with the axial direction, with the unwind angle being maintained between about 80° to about 100°.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended Figs., in which:

FIG. 1 shows a schematic of an exemplary unwinding system for unwinding a fiber from a bobbin;

FIG. 2 shows a schematic of a portion of the exemplary unwinding system of FIG. 1 from another angle;

FIG. 3 shows a perspective view of an exemplary bobbin apparatus, such as for use with the exemplary unwinding system of FIG. 1; and

FIG. 4 shows an exemplary method of intelligently unwinding a fiber from a bobbin.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

An intelligent unwind system is generally provided, along with methods of its use. In particular embodiments, a unwinding system uses at least one sensor (e.g., an optical sensor) to assess the fiber position, and a system of motors and/or drivers that align the fiber tow unwinding from the bobbin into the downstream receivers (e.g., a pulley) so as to minimize processing damage of the fiber as it leaves the surface of the wound fibers on the bobbin and enters the pulley. In particular, any scraping as the fiber unwinds from the bobbin, either with adjacent fibers on the bobbin and/or the bobbin surface, can be minimized by keeping the payoff angle (i.e., the first angle described below) near 90°. In one embodiment, the at least one sensor (e.g., a light sensor) is utilized to establish the position of the fiber as it is payed off of the bobbin. The bobbin can then be constantly aligned, in real-time, such that fiber is centered into the pulley. As such, the intelligent unwind system manages all aspects of the fiber handling, particularly when utilized within a vacuum chamber. The intelligent unwind system improves fiber quality, tow coating quality, thereby allowing the CMC raw material supply chain to reach industrial supply levels.

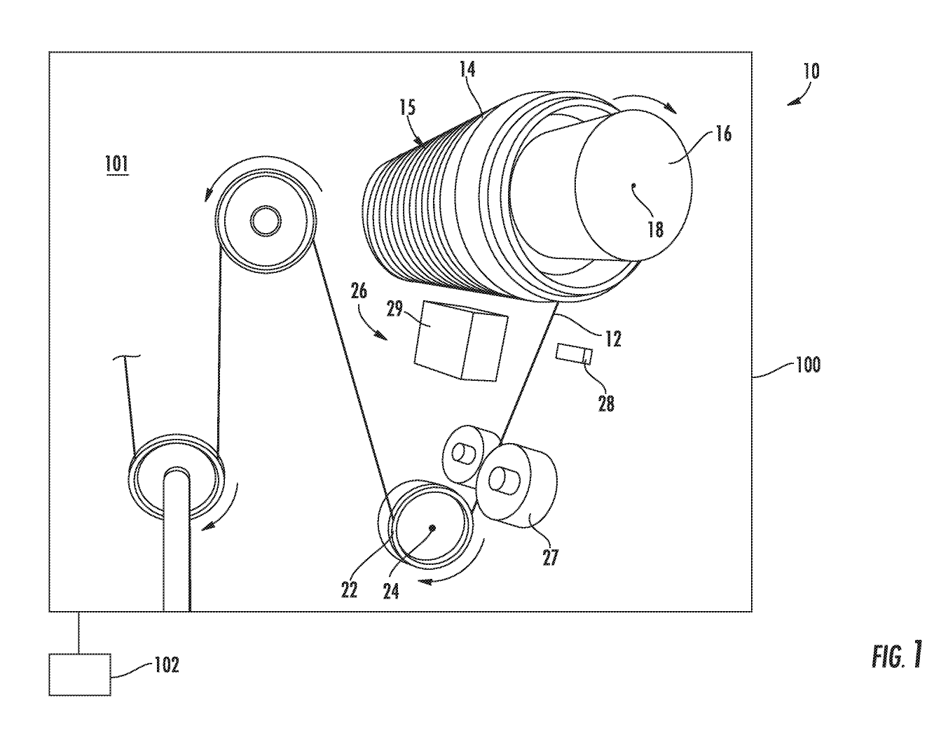

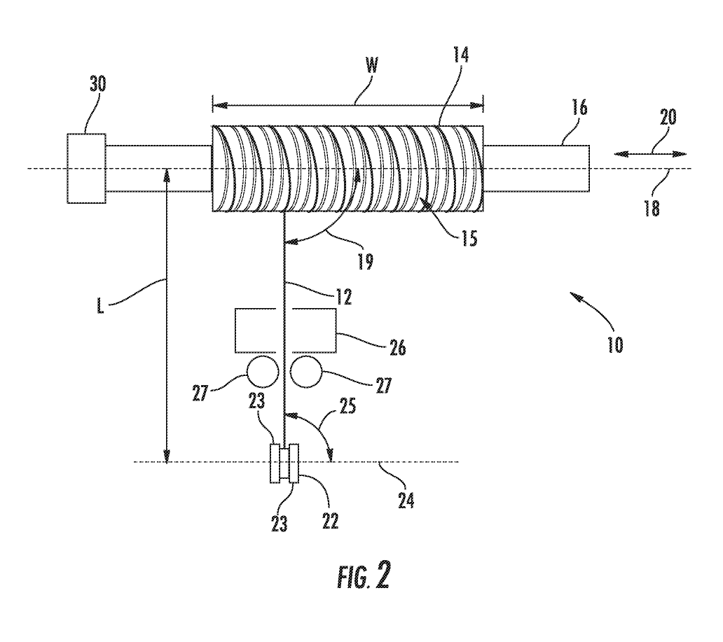

Referring to the drawings, FIG. 1 shows an exemplary unwinding system 10 for unwinding a fiber 12 from a bobbin 14 rotatably mounted around an axle 16. The axle 16 defining a first axis 18 extending an axial direction 20, as shown in FIG. 2, such that the bobbin 14 is rotatable around the first axis 18. Additionally, the bobbin 14 is controllably movable along the axial direction 20 to control the angle of the fiber 12 coming off of the bobbin 14. Consequentially, the angle of the fiber 12 going into the pulley 22 is controlled. As shown, the fiber 12 extends tangentially from a surface 15 of the bobbin 14, and into a pulley 22 positioned to receive the fiber 12 from the bobbin 14. The pulley 22 is rotatable around a second axis 24. In one embodiment, the pulley 22 is in a fixed location along the second axis 24.

As more particularly shown in FIG. 2, a sensor 26 is positioned between the bobbin 14 and the pulley 22. The sensor 26 is configured to determine the position of the fiber 12 with respect to the pulley 22 along at least one point of the length of the fiber 12. As stated, the fiber 12 extends a length from the bobbin 14 to the pulley 22. When a tension is applied on the fiber 12, the fiber length extends tangentially from the surface 15 of the bobbin 14 and tangentially into the pulley 22. Thus, the length of the fiber 12 between the bobbin 14 and the pulley 22 is substantially the same as the length L between the first axis 18 and the second axis 24.

The fiber 12 defines a first angle 19 with the first axis 18 as it is unwound from the surface 15 of the bobbin 14. Similarly, the fiber 12 defines a second angle 25 with the second axis 24 as it is received into the pulley 22. The unwinding system 10 is utilized to move the bobbin 14 along the axial direction 20 of the first axis 18 (e.g., moving the bobbin 14 along the axial direction 20 of the axle 16) such that the first angle and the second angle are kept as close to 90° as possible. For example, each of the first angle 19 and the second angle 25 can be maintained between about 80° to about 100°, such as about 85° to about 95° (e.g., about 88° to about 92°). Thus, any fraying of the fiber 12 is minimized as it enters the pulley 22, since the fiber 12 moves into the pulley such that the fiber 12 avoids contact with the pulley sides 23 and scraping against other fibers as it leaves the surface of the wound bobbin.

Referring again to FIG. 1, the unwinding system 10 is shown encased within a vacuum chamber 5. A pump 102 is fluidly connected to the vacuum chamber so as to adjust the pressure within the vacuum chamber 5. As such, the environment 101 within the vacuum chamber 5 can be controlled as desired. In particular embodiments, the environment 101 within the vacuum chamber 5 can be evacuated to an unwinding pressure of about 1 torr to about 5 torr (e.g., about 2 torr to about 3 torr) during the unwinding process. However, it should be noted that the presently described system can be used in any vacuum level, any pressure, or even in a chemical environment. The presently described system is particularly suitable for such processes due to the space saving design in a chamber.

Controlling of the first angle 19 and the second angle 25 through lateral movement of the bobbin 14 is particularly useful when the length L between the first axis 18 and the second axis 24 is relatively small with respect to the width W of the bobbin 14 (e.g., within a vacuum chamber). Since the fiber is wound around the bobbin 14 along most of its width W, the fiber 12 is unwound from the bobbin 14 from a changing point along its width. The closer the bobbin 14 is to the pulley, the more exaggerated the first angle 19 and the second angle 25 can become, if the bobbin 14 is not moved laterally in the axial direction 20. For example, the length L of the fiber 12 from the bobbin 14 to the pulley 22 can be about 50% to about 1000% of the width of the bobbin 14 along the first axis 18.

In one embodiment, the sensor 26 is a light sensor having a light emitter 28 (e.g., via a LED array) and a receiver 29 (e.g., a camera) that detects the location of the fiber 12 between the bobbin 14 and the pulley 22. The sensor 26 can then generate a signal that is received at a controller 30. The can move the bobbin 14 laterally in the axial direction 20 along the axle 16. The controller 30 is configured to move the bobbin 14 laterally in the axial direction 20 along the first axis 18.

The controller 30 may include a discrete processor and memory unit (not pictured). The processor may include a digital signal processor (DSP), an application specific integrated circuit (ASIC), a field programmable gate array (FPGA) or other programmable logic device, discrete gate or transistor logic, discrete hardware components, or any combination thereof designed and programmed to perform or cause the performance of the functions described herein. The processor may also include a microprocessor, or a combination of the aforementioned devices (e.g., a combination of a DSP and a microprocessor, a plurality of microprocessors, one or more microprocessors in conjunction with a DSP core, or any other such configuration).

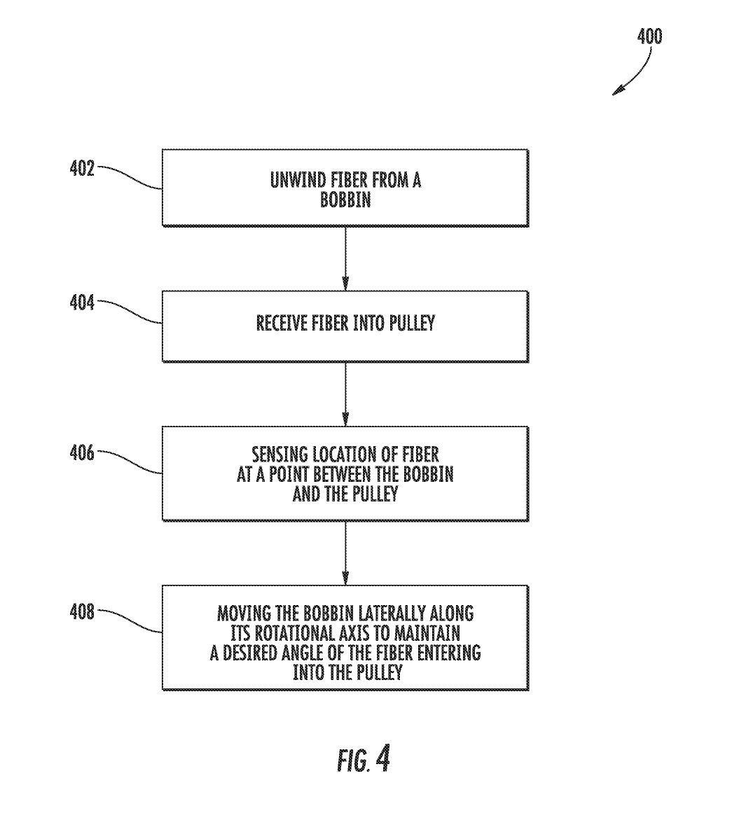

Additionally, the memory device(s) may generally comprise memory element(s) including, but not limited to, computer readable medium (e.g., random access memory (RAM)), computer readable non-volatile medium (e.g., a flash memory), a compact disc-read only memory (CD-ROM), a magneto-optical disk (MOD), a digital versatile disc (DVD), and/or other suitable memory elements. The memory can store information accessible by processor(s), including instructions that can be executed by processor(s). For example, the instructions can be software or any set of instructions that when executed by the processor(s), cause the processor(s) to perform operations. For the embodiment depicted, the instructions include a software package configured to operate the controller 30 to, e.g., execute the exemplary method 400 described below with reference to FIG. 4.

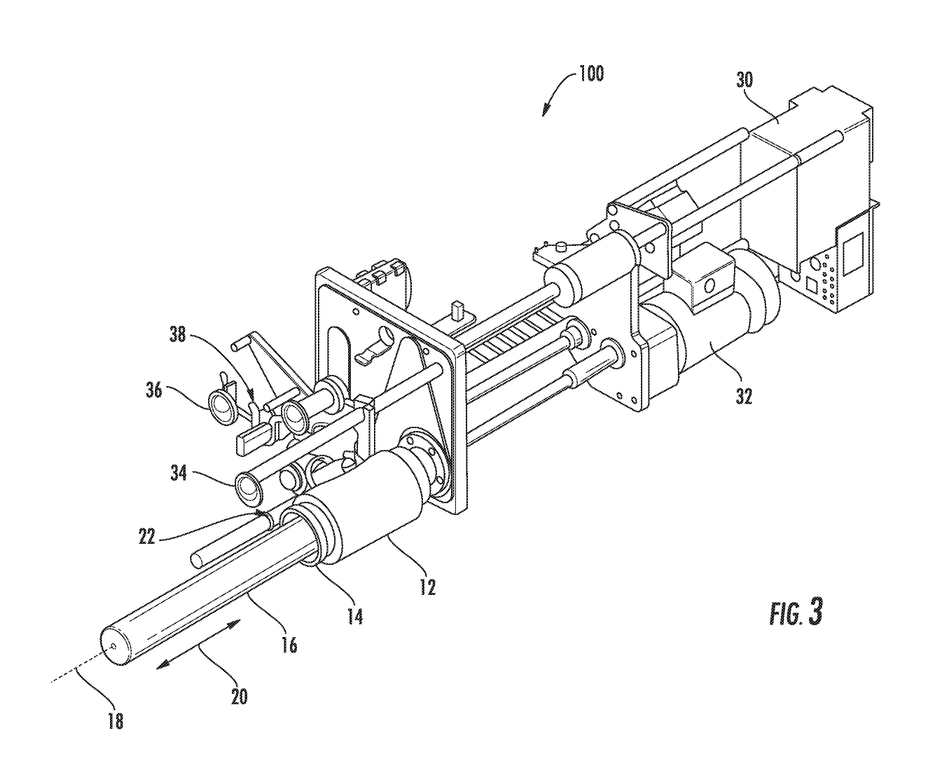

Referring now to FIG. 3, an exemplary bobbin apparatus 100 is generally shown that may be utilized with the unwinding system 10. The bobbin apparatus 100 includes the bobbin 14, the controller 30, and a motor 32 attached to the bobbin 14 and configured to move the bobbin 14 in the axial direction 20. The motor 32 can actuate the bobbin 14 laterally in the axial direction 18 as controlled by the controller 30 in response to real-time signals received at the controller 30 from the sensor 26 regarding the position of the fiber 12 between the bobbin 14 and the pulley 22. The bobbin apparatus 100 may also include a magnetic drive mechanism for moving the bobbin 14 along the first axis 18.

As more particularly shown in FIG. 1, the fiber 12 exits the pulley 22 and is received into an idler pulley 34. Then, the fiber 12 can be received from the idler pulley 34 into a dancer pulley 36 that can be connected to a tension controller 38. The tension controller 38 is generally configured to maintain a desired tension on the fiber 12 as it is processed through the unwinding system 10. In certain embodiments, the tension controller 38 senses the load on the dancer pulley 36 (i.e. tension on the fiber) and then responds to change the tension on the fiber 12 by moving the dancer pulley 36 and/or accelerates/decelerates the rotation of the bobbin 14.

The fiber 12 is, in one embodiment, a ceramic fiber such as silicon carbide for forming a fiber reinforced ceramic matrix composites (CMCs). The resulting CMC can be a continuous uniaxial or woven fibers of ceramic material embedded in a ceramic matrix. These materials are designed to have a relatively weak fiber-matrix bond strength compared to the matrix strength so as to increase overall composite strength and toughness. When the CMC is loaded above a stress that initiates cracks in the matrix, the fibers debond from the matrix allowing fiber/matrix sliding without fiber fracture. The fibers can then bridge a matrix crack and transfer load to the surrounding matrix by transferring tensile stresses to frictional interfacial shear forces. Such fiber reinforced CMCs have great potential for use in aircraft and gas turbine engines due to their excellent properties at high temperatures.

FIG. 4 shows a diagram of exemplary method 400 of intelligently unwinding a fiber from a bobbin. At 402, a fiber is unwound from a bobbin rotating around a first axis extending an axial direction. The fiber is received into a pulley rotatable around a second axis at 404. The fiber extends a length from the bobbin to the pulley, and defines a first angle with the first axis and a second angle with the second axis. At 406, the location of the fiber is sensed along at least one point of the length of the fiber between the bobbin and the pulley. The bobbin is moved laterally (i.e., in the axial direction) along its rotational axis (i.e., the first axis) to maintain a desired angle of the fiber leaving the surface of the wound bobbin (e.g. the first angle) and entering into the pulley (e.g., the second angle). For example, the first angle can be maintained between about 80° to about 100°, such as about 85° to about 95° (e.g., about 88° to about 92°), and the second angle can be maintained between about 80° to about 100°, such as about 85° to about 95° (e.g., about 88° to about 92°).

Through the exemplary unwinding system 10 described herein, the fibers, usually in the form of long fiber tows, can be unwound from a bobbin (i.e., the fiber source) to begin further processing, such as coating and/or saturating with a slurry of matrix powder in suitable solvents and binders, are then can be wound onto a mandrel to form cylinders or sheets of matrix containing aligned fibers.

In one particular embodiment, a process is generally provided for producing silicon carbide-containing fiber reinforced dense silicon-silicon carbide matrix composites, where the fibers are coated with at least a silicon-doped boron nitride coating. For example, the matrix material is molten silicon infiltrated silicon-silicon carbide which possesses net shape processing capability and ease of fabrication.

As such, a dense ceramic matrix composite, such as generally having a porosity of less than about 20% by volume, can be formed according to the methods described herein. The composite comprises, in one embodiment, a fibrous material of which the fibrous material component comprises at least about 5% by volume of the composite and has at least a silicon-doped boron nitride coating {B(Si)N} with a weight ratio of silicon to total weight of the {B(Si)N} coating between about 5 weight percent to about 40 weight percent; and a composite matrix having at least about 1% by volume of a phase of elemental silicon comprising substantially silicon. The elemental silicon phase comprises substantially silicon, but may have other dissolved elements, such as boron.

A method is also generally provided for making a silicon-silicon carbide matrix composite capable of improved properties in oxidative and wet environments via depositing at least a silicon-doped boron nitride coating on a silicon carbide-containing fibrous material such that the coating substantially covers an outer surface of said fibrous material. A matrix constituent material may be admixed to include particles (e.g., carbon, silicon carbide, and mixtures thereof) with the fibrous material, and the admixture may be formed into a preform.

The preform may then be impregnated with an infiltrant comprising substantially molten silicon; and cooling said infiltrated preform to produce the silicon-silicon carbide matrix composite, where a ratio of silicon weight to total weight of said B(Si)N coating is between about 5 weight percent to about 40 weight percent.

As used herein, “carbon” includes all forms of elemental carbon including graphite, particles, flakes, whiskers, or fibers of amorphous, single crystal, or polycrystalline carbon, carbonized plant fibers, lamp black, finely divided coal, charcoal, and carbonized polymer fibers or felt such as rayon, polyacrylonitrile, and polyacetylene. “Fibrous material” includes fibers, filaments, strands, bundles, whiskers, cloth, felt, and a combination thereof. The fibers may be continuous or discontinuous. Reference to silicon carbide-containing fiber or fibrous material includes presently available materials where silicon carbide envelops a core or substrate, or where silicon carbide is a core or substrate. Other core materials which may be enveloped by silicon carbide include carbon and tungsten. The fibrous material can be amorphous, crystalline, or a mixture thereof. The crystalline material may be single crystal or polycrystalline. Examples of silicon carbide-containing fibrous materials are silicon carbide, Si—C—O, Si—C—O—N, Si—C—B, and Si—C—O-Metal where the Metal component can vary, but frequently is titanium, zirconium, or boron. There are processes known in the art which use organic precursors to produce silicon carbide-containing fibers which may introduce a wide variety of elements into the fibers. Examples of these fibers include NICALON™ HI-NICALON™, and HI-NICALON S™, registered trademarks of Nippon Carbon Company, Ltd., Yokohama, Japan; TYRANNO™ fibers, a registered trademark of Ube Industries, Ltd., Ube City, Yamaguchi, Japan; and SYLRANIC™ fibers, a registered trademark of Dow Corning Corporation, Midland, Mich.

In carrying out the present process, a coating system is deposited on the fibrous material which leaves at least no significant portion of the fibrous material exposed, and preferably, the entire material is coated. The coating system may contain one coating or a series of coatings. If there is only one coating, it is a silicon-doped boron nitride {B(Si)N} coating or a graded coating of boron nitride to silicon doped boron nitride. The coating should be continuous, free of any significant porosity and preferably it is pore-free and significantly uniform. The silicon-containing compound in the coating is present in a sufficient amount to have a weight ratio of silicon to total weight of the B(Si)N coating between about 5 weight percent to about 40 weight percent. The preferred range is about 10 to 25 weight percent, and the most preferred range is about 11 to 19 weight percent.

The B(Si)N coating can be thought of chemically as an atomic mixture of boron nitride (BN) and silicon nitride (Si₃N₄), which can be amorphous or crystalline in nature. Different levels of silicon doping would correspond to different ratios of BN to Si₃N₄, and a complete range of B(Si)N compositions can be envisioned from pure BN to pure Si₃N₄. At one extreme of this range, pure BN gives good fiber-matrix debonding characteristics for a ceramic matrix composite, but the oxidation/volatilization resistance is poor. At the other extreme, pure Si₃N₄ has very good oxidation/volatilization resistance, but does not provide a weak fiber-matrix interface for fiber debonding during composite failure. At intermediate compositions, there exists a range of silicon contents where the B(Si)N provides both good fiber-matrix debonding characteristics and has good environmental stability. A range of silicon weight percent in the B(Si)N coating is about 5 to about 40 weight percent, and preferably about 10 to about 25 weight percent, and most preferably about 11 to about 19 weight percent silicon.

In addition to at least a B(Si)N coating, other configurations containing B(Si)N can also be used, such as multiple layers of B(Si)N with initial and/or intermediate carbon layers, or an initial layer of B(Si)N followed by further coatings of silicon carbide or Si₃N₄, or with additional layers of a silicon-wettable coating over the B(Si)N, such as carbon, or combinations of the above.

Still further examples of coating systems used in any combination with a B(Si)N coating on the fibers or fibrous material are: boron nitride and silicon carbide; boron nitride, silicon nitride; boron nitride, carbon, silicon nitride, etc. Examples of further coatings on the fibrous material that can be utilized include but are not limited to nitrides, borides, carbides, oxides, silicides, or other similar ceramic refractory material. Representative of ceramic carbide coatings are carbides of boron, chromium, hafnium, niobium, silicon, tantalum, titanium, vanadium, zirconium, and mixtures thereof. Representative of the ceramic nitrides useful in the present process are the nitrides of hafnium, niobium, silicon, tantalum, titanium, vanadium, zirconium, and mixtures thereof. Examples of ceramic borides are the borides of hafnium, niobium, tantalum, titanium, vanadium, zirconium, and mixtures thereof. Examples of oxide coatings are oxides of aluminum, yttrium, titanium, zirconium, beryllium, silicon, and the rare earths. The thickness of the coatings may range between about 0.3 to 5 micrometers.

As stated, the fibrous material may have more than one coating. An additional protective coating may be wettable with silicon and be about 500 Angstroms to about 3 micrometers. Representative of useful silicon-wettable materials is elemental carbon, metal carbide, a metal coating which later reacts with molten silicon to form a silicide, a metal nitride such as silicon nitride, and a metal silicide. Elemental carbon is preferred and is usually deposited on the underlying coating in the form of pyrolytic carbon. Generally, the metal carbide is a carbide of silicon, tantalum, titanium, or tungsten. Generally, the metal silicide is a silicide of chromium, molybdenum, tantalum, titanium, tungsten, and zirconium. The metal which later reacts with molten silicon to form a silicide must have a melting point higher than the melting point of silicon and preferably higher than about 1450° C. Usually, the metal and silicide thereof are solid in the present process. Representative of such metals is chromium, molybdenum, tantalum, titanium, and tungsten.

Known techniques can be used to deposit the coatings which generally is deposited by chemical vapor deposition using low pressure techniques.

In this process, fibers may be bundled in tows and coated with a coating or combination of coatings. The tows are formed into a structure, which is then infiltrated with molten silicon. In these methods, a boron nitride coating on the fiber is often used to protect the fiber from attack by molten silicon or for debonding. The silicon-doped boron nitride coating would then be in addition to or in place of the undoped boron nitride coating. The coatings in this invention can be graded from an undoped boron nitride to a silicon doped boron nitride coating. Non-graded coatings are also contemplated for use in this invention.

Another method used to make silicon carbide-silicon composites uses fibers in the form of cloth or 3-D structure, which are layered into the desired shape. Boron nitride coating is deposited on the cloth layers by chemical vapor infiltration as mentioned above, and a silicon-doped boron nitride coating would then be in addition to or in place of the undoped boron nitride coating. Additional coatings of silicon carbide or silicon nitride may be present on the boron nitride coating. The coatings can be graded from an undoped boron nitride to a silicon doped boron nitride coating. However, non-graded coatings are also contemplated for use with these processes. The structure is then processed in a slurry and melt infiltrated with molten silicon. The molten silicon may contain minute amounts of other elements, such as boron and molybdenum.

As stated above, the coated fibrous material is admixed with a matrix constituent material which comprises at least a carbon or silicon carbide or mixture of carbon and silicon carbide material. Other elements or compounds may be added to the admixture to give different composite properties or structure. The particular composition of the admixture is determinable empirically and depends largely on the particular composition desired, i.e., the particular properties desired in the composite. However, the admixture always contains sufficient elemental carbon, or silicon carbide, or mixtures of carbon and silicon carbide, to enable the production of the present silicon-silicon carbide matrix composite. Specifically, the preform should contain sufficient elemental carbon or silicon carbide or mixtures of carbon and silicon carbide, generally most or all of which may be provided by the admixture and some of which may be provided as a sacrificial coating on the fibrous material, to react with the molten silicon infiltrant to produce the present composite, containing silicon carbide and silicon. Generally, elemental carbon ranges from about 0% by volume, or from about 10% or 20% by volume, to almost about 100% by volume of the admixture.

The mixture of carbon or silicon carbide or carbon and silicon carbide in the preform can be in the form of a powder and may have an average particle size of less than about 50 microns, more preferably less than about 10 microns. The molten silicon that infiltrates the preform is comprised substantially of silicon, but may also contain elemental boron, which has limited solubility in the molten silicon. The silicon infiltrant may also contain boron-containing compounds or other elements or compounds.

The admixture in the preform containing the carbon or silicon carbide or mixture of silicon carbide and carbon, is wetted by the molten silicon infiltrant. In carrying out the present process, the preform is contacted with the silicon infiltrant by an infiltrating means. The infiltrating means allow the molten silicon infiltrant to be infiltrated into the preform. In the present process, sufficient molten silicon infiltrant is infiltrated into the preform to produce the present composite. Specifically, the molten silicon infiltrant is mobile and highly reactive with any carbon present in the preform to form silicon carbide. Pockets of a silicon phase also form in the matrix.

The period of time required for infiltration is determinable empirically and depends largely on the size of the preform and extent of infiltration required. Generally, it is complete in less than about 60 minutes, and often in less than about 10 minutes. The resulting infiltrated body is cooled in an atmosphere and at a rate which has no significant deleterious effect on it.

The present composite then is comprised of coated fibrous material and a matrix phase. The matrix phase is distributed through the coated fibrous material and generally it is substantially space filling and usually it is interconnecting. Generally, the coated fibrous material is totally enveloped by the matrix phase. The matrix phase contains a phase mixture of silicon carbide and silicon. The fibrous material comprises at least about 5% by volume, or at least about 10% by volume of the composite. The matrix contains a silicon carbide phase in an amount of about 5% to 95% by volume, or about 10% to 80% by volume, or about 20% to 60% by volume of the composite. The matrix may contain an elemental silicon phase in an amount of about 1% to 30% by volume of the composite.

The impregnated shapes made therefrom are at this stage of the process commonly termed “prepregs.” A prepreg can be reshaped as desired and ultimately formed into a preform for a composite article. The preform is subjected to a burn-out step to remove organic or other fugitive coating components. The preform is finally consolidated into a dense composite material by reaction with molten silicon at high temperature.

The fibers are coated for several purposes such as to protect them during composite processing, to modify fiber-matrix interface strength and to promote or prevent mechanical and/or chemical bonding of the fiber and matrix. A number of different techniques have been developed for applying fiber coatings, such as slurry-dipping, sol-gel, sputtering and chemical vapor deposition (CVD). Of these, CVD has been most successful in producing impervious coatings of uniform thickness and controlled composition. In a typical CVD process, fibers and reactants are heated to some elevated temperature where coating precursors decompose and deposit as a coating. CVD coatings can be applied either in a batch or continuous mode. In a batch mode, a length of fiber is introduced into a reactor and kept stationary throughout the coating process while reactants are passed through the reactor. In a continuous process, fibers and coating precursors are continuously passed through a reactor. Continuous fiber coating processes are preferred for composites processed by filament winding. As such, the exemplary unwinding system 10 described herein is particularly suitable for providing a continuous fiber into such a process.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of coating a fiber, the method comprising:
unwinding a silicon carbide-containing fibrous material from a bobbin rotatably mounted around an axle, wherein the bobbin is moved along the axial direction such that the silicon carbide-containing fibrous material defines an unwind angle with the axial direction, the unwind angle being maintained between about 80° to about 100°; and
forming a boron nitride coating onto the silicon carbide-containing fibrous material.

2. The method of claim 1, further comprising:
admixing a particulate material comprising infiltration-promoting particles with said fibrous material.

3. The method of claim 2, wherein the infiltration-promoting particles are selected from the group consisting of carbon, silicon carbide, and mixtures thereof.

4. The method of claim 2, further comprising:
forming said admixture into a preform.

5. The method of claim 4, further comprising:
infiltrating said preform with an infiltrant comprising substantially molten silicon.

6. The method of claim 5, further comprising:
cooling said infiltrated preform to produce the silicon-silicon carbide matrix composite.

7. The method of claim 6, wherein a weight percent of silicon in said B(Si)N coating is between about 5 to about 40 weight percent and wherein said fibrous material comprises at least 5% by volume of the composite.

8. The method of claim 1, wherein said coating substantially covers an outer surface of said fibrous material.

9. The method of claim 1, wherein unwinding a silicon carbide-containing fibrous material from a bobbin comprises:
receiving the fiber into a pulley rotatable around a second axis, wherein the fiber extends a length from the bobbin to the pulley;
sensing a location of the fiber along at least one point of the length of the fiber between the bobbin and the pulley; and
moving the bobbin laterally along the axial direction such that the first angle is maintained between about 80° to about 100°.

10. The method of claim 1, wherein the boron nitride coating has a thickness of about 0.3 micrometers to about 5 micrometers.

11. The method of claim 1, further comprising:
a protective coating on the boron nitride coating, wherein the protective coating comprises a silicon-wettable material.

12. The method of claim 11, wherein the silicon-wettable material comprises elemental carbon, a metal carbide, a metal coating reactive with molten silicon to form a silicide, a metal nitride, or a metal silicide.

13. The method of claim 11, wherein the protective coating has a thickness of about 500 Angstroms to about 3 micrometers.
